(19) United States
(12) Patent Application Publication
(10) Pub. No.: US 2007/0189323 A1
(43) Pub. Date: Aug. 16, 2007

(54) Serial data bus, motion system and method for the event-driven transmission of messages

(75) Inventors: Werner Swoboda, Boeblingen (DE); Benno Hagel, Pfullingen (DE); Franz Ott, Hechingen-Boll (DE); Friedrich Arnold, Reutlingen (DE)

Correspondence Address: FACTOR & LAKE, LTD, 1327 W. WASHINGTON BLVD., SUITE 5G/H, CHICAGO, IL, 60607, US

(73) Assignees: EISENMANN MASCHINENBAU GMBH & CO. KG, Boblingen (DE); BERGHOF AUTOMATIONSTECHNIK GMBH, Eningen (DE)

(21) Appl. No.: 10/574,042

(22) PCT Filed: Sep. 21, 2004
(86) PCT No.: PCT/EP04/10555

§ 371 Date: Aug. 30, 2006

(30) Foreign Application Priority Data
Sep. 29, 2003 (DE) 103 45 359.8

(51) Int. Cl. H04L 12/403

(52) U.S. Cl. 370/451

(57) ABSTRACT

The invention relates to a serial data bus including a data line for transmitting electrical signals representing bit states and a plurality of multi-master subscribers between which messages can be exchanged via the data line in an event-driven manner according to the broadcast principle. At least two subscribers have a transceiver head, inductively connected to the data line, via which contactless electrical signals are picked up from the data line or transferred thereto. An amplifier (is galvanically connected to the data line and is adapted to receive electrical signals that have been inductively transferred by the at least two subscribers to the data line and to feed them back to the data line once amplified. Due to its inductive connection, the data bus is especially low-maintenance and also suitable for hazardous surroundings. The contactless connection makes the data bus especially suitable for use in transport systems in production engineering and generally for use in systems having parts that are mobile relative one another and between which a data exchange is desired.

The invention relates to a serial data bus having a data line for the transmission of electrical signals representing bit states and having a plurality of multi-master subscribers between which messages can be exchanged via the data line in an event-driven manner according to the broadcast principle. The invention furthermore relates to a motion system having a first part and a second part, which is arranged mobile relative to the first part. The invention also provides a serial method for the event-driven transmission of messages between a plurality of multi-master subscribers according to the broadcast principle via a data bus.

A serial data bus, a transport system and a method of the said type are widely known in the prior art. An example of such a data bus is the CAN bus which, in particular, is used in automation technology and in motor vehicles. The CAN bus is a cost-effective but nevertheless very powerful field bus which has particularly good security against interference and failure, even under very severe ambient electrical conditions. The CAN bus is furthermore distinguished by a particularly high real-time capability and high transmission reliability.

In a CAN bus, information is exchanged between a plurality of equally authorised subscribers, often also referred to as nodes, via messages (telegrams) of variable length which contain different fields. The transmission of messages by the subscribers is in this case event-driven. This means that the transmission of a message can be prompted by each subscriber itself. This unsynchronised type of data transmission contrasts with synchronous bus systems, in which subscribers can transmit messages only within time slots assigned to them. Since none of the subscribers a priori has precedence over the other subscribers, the CAN bus is classed among the multi-master bus systems.

Each message transmitted by a subscriber is sent according to the broadcast principle to all the other subscribers and received by them. The messages do not contain actual addressing information, but merely identification bits which are uniquely specified bus-wide and characterise the content of the message and its priority.

A symmetrical or asymmetrical two-wire line is selected as the data line in a CAN bus, although it is also possible to resort to a single-wire line in case of interference if corresponding switching devices are provided.

CAN bus systems and similar bus systems of the type mentioned in the introduction are used inter alia as a communication medium for track-bound transport systems, such as those used for example in the form of electrically operated overhead conveyors for transporting motor vehicle bodywork in automobile assembly. The bus system is in this case intended to make it possible to control the vehicles of the transport system, which also involves exchange of information directly between individual vehicles. The individual vehicles have to date being connected to the data line of the bus system via sliding contacts. Tapping via sliding contacts, however, is often disadvantageous for several reasons. On the one hand, the sliding contacts are susceptible to wear and therefore require intensive maintenance. This restricts the system availability; in certain applications, moreover, the inevitable carbon abrasion of sliding contacts can become in tolerable. Furthermore, sliding contacts must not be used in environments at risk of explosion since the formation of arc discharges cannot reliably be prevented.

For these reasons—albeit in connection with different types of transmission systems—it has variously been proposed that the information needed for control should be transmitted contactlessly to the vehicles in such transport systems.

For example, DE 195 12 523 A1 discloses a transport system in which a contactlessly operating data transmission system is combined with a contactlessly operating energy transmission system. The data transmission system has a fixed station functioning as a master and a plurality of mobile stations functioning as slaves, which respectively comprise an RF modem with an RF transmission part and an RF reception part. A slotted coaxial cable is used as the data line. Switches make it possible to change from transmission to reception operation, so that bidirectional data interchange is possible.

DE 196 49 682 C2 discloses a data transmission system which is similar, but in which a single waveguide is used for the energy transmission and the data transmission. The energy transmission is carried out, for example, with a narrowband signal of high amplitude at 100 kHz. Frequency bands in the MHz range are used for the data transmission. A superposition of a radiofrequency data signal with a low-frequency carrier for the energy transmission is also described in U.S. Pat. No. 5,927,657 A.

WO 98/57413 discloses a transport system in which an arrangement of an electrical conductor and supports carrying and insulated from it, for example an aluminium profile, is used as the data line for contactless data transmission to the vehicles.

However, none of the concepts proposed to date for contactless data transmission to the vehicles in transport systems is satisfactory, since they do not fulfil the stringent requirements of security against interference and failure that are demanded by modern automation technology.

It is therefore an object of the invention to refine a serial data bus, a motion system and a method of the type mentioned in the introduction, so as to achieve good security against failure and robustness even under adverse environmental conditions.

For a data bus of the type mentioned in the introduction, this object is achieved in that at least two subscribers have a transmission/reception head which can be inductively coupled to the data line and via which electrical signals can be tapped contactlessly from the data line and transmitted onto it, and in that an amplifier which receives electrical signals that have been transmitted inductively onto the data line by the at least two subscribers, and couples them back into the data line after their amplification, is DC-connected to the data line.

With respect to the motion system, the object is achieved in that subscribers of such a data bus are arranged statically on the two parts.

With respect to the method, the object is achieved by the following steps:
a) contactless transmission of an electrical signal by a subscriber onto a data line of the data bus via a transmission/reception head, coupled inductively to the data line, of the subscriber;
b) reception of the electrical signal attenuated by the inductive transmission by an amplifier DC-connected to the data line;
c) amplification of the received signal in the amplifier;
d) coupling of the amplified signal onto the data line;
e) reception of the amplified signal transmitted onto the data line by a transmission/reception head, coupled inductively to the data line, of another subscriber.

Owing to the comparatively large attenuation experienced by the electrical signals during the inductive coupling between the transmission/reception head and the data line, the signals coupled directly into the data line by a subscriber achieve only a relatively low signal level. It is so low that the other subscribers could not, or could not reliably receive these signals since corresponding attenuation also occurs during extraction from the line. By retransmitting the signals with an increased signal level, the amplifier provided according to the invention makes it possible to raise the signal-to-noise ratio so that the probability of error during the data transmission is significantly reduced. This also has a positive effect when the data bus is provided with error detection, for example a cyclic redundancy check (CRC), since the required number of message retransmissions is thereby reduced so that the real-time capability of the data bus is increased. Amplification of the signals is also expedient with a view to linking the data bus with other communication devices, for example a superordinate central computer.

Owing to the contactless coupling of the at least two subscribers to the data line, the data bus according to the invention is particularly suitable for environments at risk of explosion since, in contrast to sliding contacts, spark formation cannot take place. The serial data bus can furthermore be used advantageously in clean-room environments since the inductive coupling does not generate any wear, as is the case with sliding contacts. On the other hand, the data bus according to the invention can also improve the reliability of the data transmission in a particularly dirty environment, since dirt depositing on the data line does not significantly impair the inductive coupling of the subscribers. When sliding contacts are used, however, dirt depositing in the contact region can sensitively interfere with the electrical connection.

The data bus according to the invention may also be operated advantageously with only one subscriber coupled inductively to the data line. Coupling of signals amplified by the amplifier into the data line is then superfluous and can be obviated. The data bus may nevertheless have such an amplifier, so that the data bus can be operated using the same system components with one or even a plurality of inductively coupled subscribers.

Use with only one inductively coupled subscriber may be envisaged in particular for motion systems such as elevators, in which only one part moves while the other parts, which communicate with one another and with the mobile part via the data line, are static. In an elevator, for example, the mobile subscriber may represent a control arranged in the elevator compartment while the static subscribers are arranged on the storeys.

The provision of only one inductively coupled subscriber may also be envisaged for machines in which only a single actuator or sensor on a moving machine part has to exchange messages with a central control.

Another advantage of the data bus according to the invention is that it can be constructed mainly with inexpensive standard components already available on the market. Only the amplifier and the transmission/reception heads of the subscribers, and possibly the data line, are added as new components. On the other hand, the devices needed for the regeneration and evaluation of messages may optionally be adopted without further modification. If the messages comply with the CAN standard (ISO 11898), then it is feasible in particular to use the components standardised for CAN bus systems.

Even if the messages do not correspond to the message format established in the CAN standard, then in a preferred configuration of the invention they may contain priority bits by the reception of which, in the event of simultaneous message transmissions by a plurality of subscribers, a subscriber can determine whether it has the priority to transmit data bits by means of a comparison with priority bits which it itself transmits. This ensures that whenever there is a unique priority order, one of the subscribers can always use the data lines to send messages. Mutual blocking of a plurality of subscribers, as may sometimes occur in other bus systems, can be avoided in this way.

In an advantageous refinement of this configuration, a subscriber does not have the priority to transmit data bits when it receives a signal that represents a dominant logical bit state and it approximately simultaneously transmits a signal that represents a recessive logical bit state. The effect achieved by this nondestructive bitwise arbitration is that the subscribers one by one cease to transmit signals in the event of simultaneous message transmissions, and specifically in the reverse order of the priority of the messages being transmitted.

In the data bus according to the invention, the signal representing the dominant bit state may be a current pulse and the signal representing the recessive bit state may be the absence of a current pulse. Other forms of signals may nevertheless be envisaged, for example pulse trains of different frequency. What is crucial here is merely that a superposition of a signal representing the dominant bit state with a signal representing the recessive bit state leads to be combined signal which is not identical to the recessive output signal. This is because only in this way can the subscribers recognise that another subscriber has sent a signal representing the dominant bit state while it itself has only sent a signal representing the recessive bit state. It is to be understood that a current pulse in an ohmic conductor also entails a voltage pulse, so that the signals can be described by voltage variations.

In a preferred configuration of the invention, the transmission/reception head comprises
a) a transmission coil,
b) a reception coil which may be combined with a transmission coil to form a transmission/reception coil,
c) a transmission module by which electrical signals, which can be applied to the transmission coil, can be generated from digital information,
d) a reception module by which digital information can be generated from electrical signals that can be tapped by the reception coil, and
e) a logic unit, connected to the transmission module and the reception module, for collating and evaluating messages from digital information received by the reception module and for generating digital information for the transmission module.

The logic unit may furthermore have the task of determining the priority of messages, if the messages do not contain the aforementioned priority bits. If the messages have the format established in the CAN standard, then the logic unit may contain inexpensive standard components.

For the sake of transmission reliability, it is expedient to prevent a signal amplified by the amplifier from overlapping a signal which has been coupled into the data line by one of the subscribers at a later time. For example, this may be ensured in that after reception of a signal from one of the at least two subscribers, the amplified signal can be transmitted onto the data line by the amplifier within 50%, preferably within 25%, of the cycle length which lies at least between two signals transmitted onto the data line by one of the at least two subscribers.

Inductively coupling the subscribers onto the data line according to the invention allows the subscribers to be positioned in a spatially flexible way along the data line. Since the inductive coupling cannot create any sparks, the data bus can even be used in environments at risk of explosion. Nevertheless, the data bus according to the invention may be designed so that individual subscribers are coupled to the data line conventionally rather than inductively.

It is particularly preferred, however, for at least one subscriber to be arranged so that it can travel along the data line. In this way, the advantages of contactless inductive coupling become particularly significant. The subscriber may, for example, be a sensor which is intended to take measurement values at different positions.

If the subscriber is a track-bound vehicle, however, then this provides a transport system according to the invention which, for example, may be designed as an overhead conveyor system for transporting objects, in particular motor vehicle bodywork.

In such a transport system, at least one vehicle may comprise a vehicle control which is connected to the transmission/reception head. In this way, the data bus can be used to control the vehicles.

The data bus according to the invention allows data interchange between the vehicles via the data line. Position and distance information can be transmitted between the vehicles in this way, for example, so that the vehicles can essentially control themselves along the track. In general, however, it is still necessary to provide a control unit for controlling the vehicles, which specifies the paths to be taken by the vehicles and their holding positions. Such a control unit may, for example, be one of the subscribers of the data bus.

In a preferred configuration of the invention, however, the control unit for controlling the vehicles along the data bus is connected to the amplifier, for example via a CAN bus. This has the advantage that the same communication structure can be used at all control levels.

The transport system is preferably subdivided into a plurality of segments which respectively comprise a data bus having a control unit, the control units for the individual segments being connected to a superordinate central control. Since the length of the data lines which can be produced is limited, almost arbitrarily large transport networks can be produced on the basis of the data bus according to the invention by such a segmented structure. The track intended for the vehicles may in this case extend over a plurality of segments, so that vehicles can travel over segment boundaries. With the aid of the superordinate central control, the vehicles can therefore be navigated through the entire route network.

Further advantages and features of the invention will be found in the following description of an exemplary embodiment with the aid of the drawing, in which:

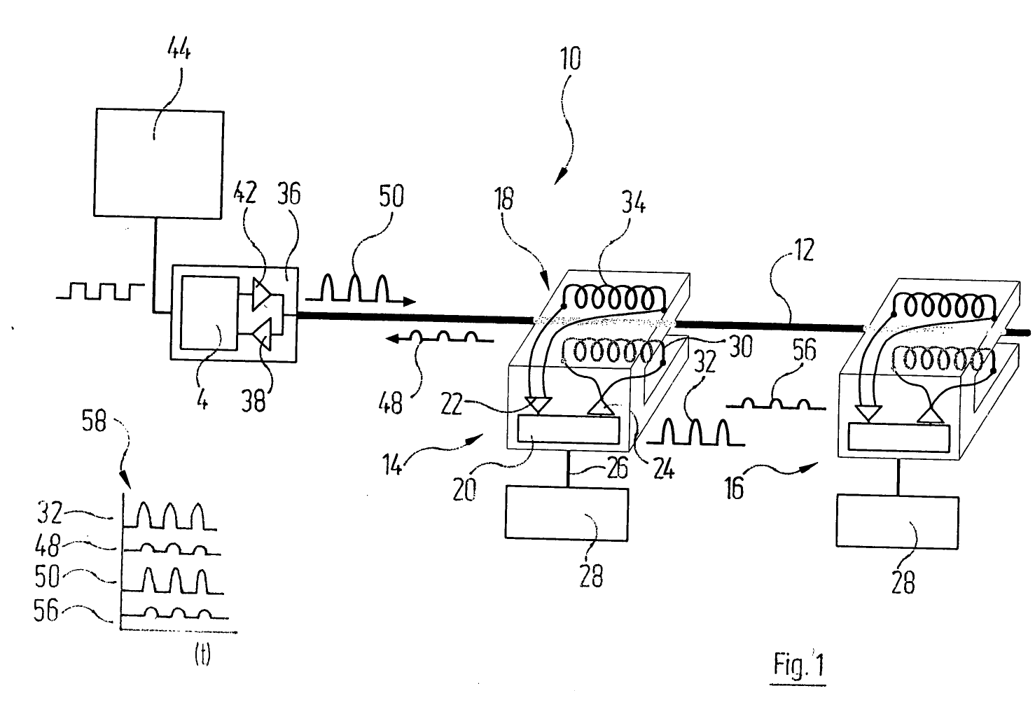

FIG. 1 shows an outline sketch of a data bus according to the invention;

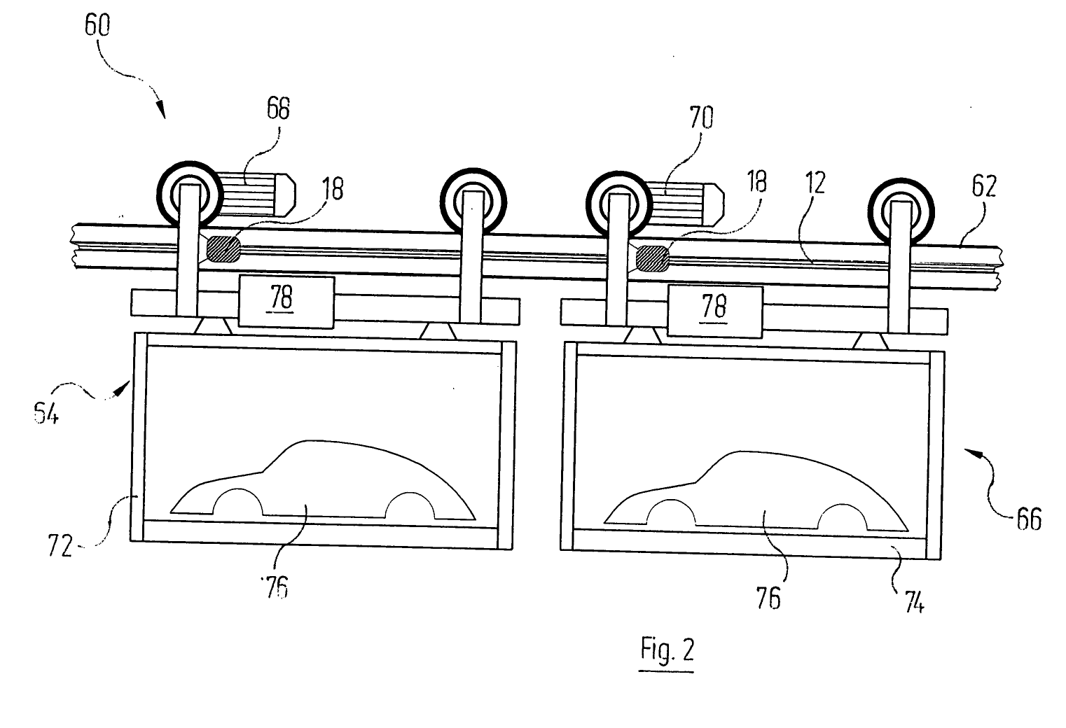

FIG. 2 shows a detail of an overhead conveyor system in a schematic side view,

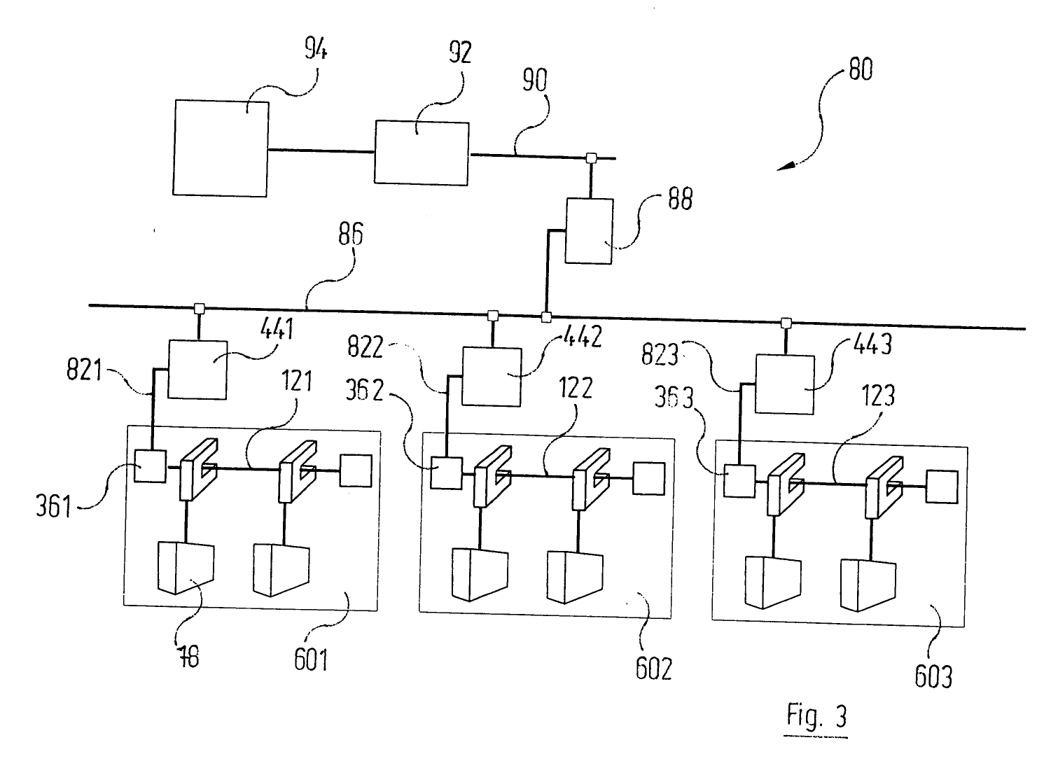

FIG. 3 shows a network for controlling a transport system by using the data bus represented in FIG. 1.

In FIG. 1, a data bus is schematically represented and denoted overall by 10. The data bus 10 comprises a data line 12, which is designed as a symmetrical two-wire line whose wires are kept spaced apart by bridges or bars. The data bus 10 also has two subscribers 14 and 16, which are constructed identically. Only the structure of the subscriber 14 will therefore be explained in detail below.

The subscriber 14 has a transmission/reception head 18, which overall has a U-shaped form. A logic unit 20, a reception module 22, a transmission module 24, a reception coil 34 and a transmission coil 30 are arranged in the transmission/reception head 18

The logic unit 20 is connected via a CAN bus 26 to a system component 28 of the subscriber 14, which may for example be a vehicle control as explained in more detail below with reference to FIGS. 2 and 3. Nevertheless, sensors or other measuring units, actuators or control devices for various purposes may also be envisaged as the system component 28. The task of the logic unit 28 is to buffer and condition the messages received via the CAN bus 26, so that they can be transmitted via the data line 12.

To this end the logic unit 20 is connected to the transmission module 24 which, from messages provided by the logic unit 20, generates electrical signals according to the CAN format that can be applied to the transmission coil 30, which is arranged in one of the limbs of the U-shaped transmission/reception head 18. A bit with the logical level 1 is converted by the transmission module 24 into a current pulse, while a bit corresponding to the logical zero corresponds to the absence of a current pulse. A transmission signal (denoted by 32) generated by the transmission module 24 is indicated by way of example on the right in FIG. 1 beside the transmission/reception head 18.

The reception module 22 is connected to the reception coil 34, and has the task of converting electrical signals obtained from the data line 12 via the reception coil 34 into digital information which can be processed further by the logic unit 20.

Another component of the data bus 10 is an amplifier, denoted overall by 36, which is DC-connected to the data line 12. The amplifier 36 contains an input amplifier 38 which amplifies electrical signals transmitted via the data line 12, and delivers them to a logic module 40. Inter alia, the logic module 40 has the task of checking whether the signals received and amplified by the input amplifier 38 are actually signals which have been generated by one of the subscribers 14 or 16. Only those signals which are not identified as interference signals are delivered by the logic module 40 to the output amplifier 42, and returned onto the data line 12. Optionally, signal regeneration may also take place in the logic module 40.

In the exemplary embodiment represented, the amplifier 36 is connected via a CAN bus to a control unit 44 which is used to control the system components 28 in the subscribers 14, 16.

The data bus 10 described above functions in the following way:

When a system component 28 of the subscriber 14 gives the prompt to communicate a message to the subscriber 16, then the relevant message is communicated via the CAN bus 26 of the subscriber 14 to the logic unit 20. The latter compiles therefrom a message corresponding to the CAN standard, which the transmission module 24 translates into a transmission signal 32 and thereby applies to the transmission coil 30.

The data line 12 runs between the limbs of the transmission/reception head 18 so that the transmission coil 30 lies in the immediate vicinity of the data line 12. The transmission coil 30 excited by the transmission signal 32 inductively generates a current in the data line 12, so that the transmission signal 32 is coupled into the data line 12. Owing to the non-negligible coupling attenuation, however, the coupled transmission signal now has only a comparatively low signal strength as indicated by 48 in FIG. 1. The attenuated coupled signal 48 is transmitted via the data line 12 to the amplifier 36. After preamplification by the input amplifier 38, this checks that the attenuated signal 48 does not merely represent interference. If it does not, then the signal 48 is re-amplified in the output amplifier 42 and returned onto the data line 12. The cycle length of the attenuated signal 48, which is 20 μs in the exemplary embodiment represented, is not changed by the amplification in the amplifier 36. If the individual pulses are temporally stretched by the coupling onto the data conductor 12, then the logic unit 40 ensures that the original pulse length, which may for example be 700 ns, is preserved during the amplification.

In the reception coils 34 of the transmission/reception heads 14 of the subscribers 14, 16, the amplified transmission signal, which is denoted by 50 in FIG. 1, induces a reception signal which is likewise attenuated comparatively strongly because of the inductive coupling. This reception signal is indicated by 56 in FIG. 1. In the reception module 22 of the transmission/reception heads 18, the reception signal 56 is amplified and converted into digital information from which the messages can be reassembled.

A graph 58 schematically represents the transmission signal 32, the attenuated transmission signal 48, the amplified transmission signal 50 and the reception signal 56 as a function of the time axis. It can be seen that the subscribers 14, 16 can receive a transmitted signal before a new signal is coupled into the data line 12. The delay with which the amplifier 36 returns a received signal onto the data line 12, after having amplified it, is merely about 1 to 2 μs in the exemplary embodiment represented and therefore about one quarter of the cycle length (bit length) which elapses between the transmission of pulses.

In the exemplary embodiment represented, as mentioned above, the assembly of the messages in the logic units 20 corresponds to the CAN standard. This means that each message contains a plurality of priority bits by which, in the event of simultaneous message transmissions by a plurality of subscribers, they can determine by way of an arbitration which message has the highest priority and therefore should be sent completely. The transmission of messages with lower priority is suspended as soon as the logic unit 20 of a subscriber 14, 16 establishes that the message transmitted by it has a lower priority. The dominant bits, by which a high priority is characterised, are reproduced by current pulses whereas recessive bits correspond to the omission of a current pulse.

Owing to the inductive coupling of the transmission/reception heads 18, the subscribers 14, 16 can travel along the data line 12. It is merely necessary to ensure consistently that the data line 12 runs between the limbs of the transmission/reception heads 18, so that inductive coupling via the reception coils 34 and transmission coils 30 is maintained. The transmission/reception head 18 may also be flat in transport systems running at ground level, and is then guided at a direct distance over the data line 12.

The mobility of the transmission/reception heads 18 along the data line 12 makes it possible to use the data bus as a communication medium in transport systems. Overhead conveyors are an example of such a transport system, for instance those used in manufacturing technology to transport objects, for example motor vehicle bodywork. FIG. 2 shows a detail of such an overhead conveyor in a schematic side view. The overhead conveyor, denoted overall by 60, comprises a rail from which vehicles 64, 66 are suspended. The vehicles 64, 66 are provided with electrical drives 68 and 70, and respectively have a support framework 72, 74 which is designed to receive vehicle bodywork 76.

The data line 12 of the data bus 10 is fastened on the rail 62. Each of the vehicles 64, 66 furthermore has a transmission/reception head 18, which engages around the data line 12 and is connected to a vehicle control 78.

FIG. 3 shows the overall network 80, which is intended for the exchange of information in the overhead conveyor system 60. The network 80 is subdivided at the bottom network level into a plurality of segments 601, 602, 603, which respectively have the structure shown in FIG. 1.

The data lines 121, 122, 123 of the segments 601, 602, 603 are respectively arranged on the rails 62 of the overhead conveyor system 60. Control units 441, 442, 443 for the segments 601, 602, 603 are respectively connected via a CAN bus 821, 822, 823 to amplifiers 361, 362, 363, and are furthermore connected via a further CAN bus 86, a converter 88 and an Ethernet bus 90 to control logic 92, which in turn exchanges information with a central control 94 of the entire assembly plant.

The individual vehicles, only the vehicle control 78 of which is indicated in FIG. 3, can move freely along the rails 62 within the individual segments 601, 602, 603. The data lines 121, 122, 123 may be laid in the rails so that they approximately abut flush with one another, so that it is possible for the vehicles 64, 66 to cross over from one segment into a neighbouring segment. All the vehicles 64, 66 can therefore be centrally controlled via the network 80. It is furthermore possible to exchange information directly between the vehicles 64, 66 via the network 80. While vehicles within a segment 601, 602, 603 can communicate directly with one another via the data lines 121, 122, 123, incorporation of the superordinate segment controls 841, 842, 843 is required for the data interchange across segments.

1. A serial data bus having a data line for the transmission of electrical signals representing bit states and having a plurality of multi-master subscribers between which messages can be exchanged via the data line in an event-driven manner according to the broadcast principle, the serial data bus comprising:
at least two subscribers each including a transmission/reception head which can be inductively coupled to the data line and via which electrical signals can be tapped contactlessly from the data line and transmitted onto it, and in that an amplifier which receives electrical signals that have been transmitted inductively onto the data line by the at least two subscribers, and couples them back into the data line after their amplification, is DC-connected to the data line.

2. The serial data bus according to claim 1, characterised in that the messages contain priority bits by the reception of which, in the event of simultaneous message transmissions by a plurality of subscribers, a subscriber can determine whether it has priority to transmit data bits by means of a comparison with priority bits which it itself transmits.

3. The serial data bus according to claim 2, characterised in that the subscriber does not have priority to transmit data bits when it receives a signal that represents a dominant logical bit state and it approximately simultaneously transmits a signal that represents a recessive logical bit state.

4. The serial data bus according to claim 3, wherein the signal representing the dominant bit state is a current pulse and the signal representing the recessive bit state is the absence of a current pulse.

5. The serial data bus according to claim 1, wherein the transmission/reception head (comprises:
a transmission coil;
a reception coil;
a transmission module by which electrical signals, which can be applied to the transmission coil, can be generated from digital information;
a reception module by which digital information can be generated from electrical signals that can be tapped by the reception coil; and,
a logic unit, connected to the transmission module and the reception module, for collating and evaluating messages from digital information received by the reception module and for generating digital information for the transmission module.

6. The serial data bus according to claim 4, wherein message priority can be determined by the logic unit.

7. The serial data bus according to claim 1, wherein after reception of the electrical signals from one of the at least two subscribers, the amplified signals can be transmitted onto the data line by the amplifier within approximately 25-50% of a cycle length which lies at least between two signals transmitted onto the data line by one of the at least two subscribers.

8. The serial data bus according to claim 1, wherein the messages have the format established in the CAN standard.

9. The serial data bus according to claim 1, wherein one of the at least two subscribers is arranged so that it can travel along the data line.

10. A motion system having a first part and a second part, which is arranged mobile relative to the first part, wherein subscribers of a data bus according to claim 9 are arranged statically on the two parts.

11. The motion system according to claim 10, adapted for design as a track-bound transport system having a track and a plurality of vehicles that travel along the track, the transport system comprising, for communication between the vehicles, a data bus according to claim 9 whose data line is arranged along the track of the transport system and whose subscribers are the vehicles.

12. The motion system according to claim 11, wherein at least one vehicle comprises a vehicle control connected to the transmission/reception head.

13. The motion system according to claim 11, wherein the amplifier is connected to a control unit for controlling the vehicles along the data bus.

14. The motion system according to claim 13, wherein the amplifier is connected to the control unit via a CAN bus.

15. The motion system according to claim 13 being subdivided into a plurality of segments which respectively comprise a data bus having a control unit, and in that the control unit for the individual segments is connected to a superordinate central control.

16. The motion system according to claim 15, wherein the track for the vehicles extends over a plurality of segments so that vehicles can travel over segment boundaries.

17. The motion system according to claim 11 being designed as an overhead conveyor system for transporting objects.

18. A serial method for the event-driven transmission of messages between a plurality of multi-master subscribers according to the broadcast principle via a data bus, the method comprising the steps of:
contactless transmission of an electrical signal by a subscriber onto a data line of the data bus via a transmission/reception head, coupled inductively to the data line, of the subscriber;
reception of the electrical signal attenuated by the inductive transmission by an amplifier DC-connected to the data line;
amplification of the received signal in the amplifier;
coupling of the amplified signal onto the data line; and,
reception of the amplified signal transmitted onto the data line by a transmission/reception head, coupled inductively to the data line, of another subscriber.

19. The method according to claim 18, such that when a subscriber simultaneously transmits a message and receives a message, it determines whether it has the priority to transmit data bits by means of a comparison of received priority bits and self-transmitted priority bits.

20. The method according to claim 21, such that a subscriber does not have the priority to transmit data bits when it receives a signal that represents a dominant logical bit state and it approximately simultaneously transmits a signal that represents a recessive logical bit state.

21. The method according to claim 20, such that the signal representing the dominant bit state is a current pulse and the signal representing the recessive bit state is the absence of a current pulse.

22. The method according to claim 18, such that the messages have the format established in the CAN standard.
